(19) United States
(12) Patent Application Publication
(10) Pub. No.: US 2005/0136191 A1
(43) Pub. Date: Jun. 23, 2005

(54) Method of coating and coating apparatus

(76) Inventors: Markus Vos, Ingelheim (DE); Frank Karbach, Dichtelbach (DE)

Correspondence Address: STRIKER, STRIKER & STENBY, 103 East Neck Road, Huntington, NY, 11743, US

(21) Appl. No.: 10/838,034

(22) Filed: May 3, 2004

(30) Foreign Application Priority Data
Dec. 18, 2003 (DE) 103 59 725.5

(51) Int. Cl. B05D 7/00; B05B 3/00

(52) U.S. Cl. 427/427.1; 118/323; 427/282

(57) ABSTRACT

During location-selective coating of areas of a substrate, other areas not to be coated are protected from coating by a mask. In order to provide a rapid location-selective coating of the substrate, a mask (3,3′) is arranged between a spray head (2) for spraying a coating material and the substrate (10) and travels with the spray head (2) during the coating process. Provisions are taken to avoid contamination of the mask (3,3′) during the coating process. The mask (3,3′) can include two elongated elements (3,3′), which define a coating slot, and a paper sheet (5) can be guided over the elongated elements (3,3′) to clean them during coating. Alternatively the mask can include two rotating disks, which define the coating slot, and excess coating material can be removed by rotating the disks.

### BACKGROUND OF THE INVENTION

1. Field of the Invention

The present invention relates to a method of coating a given surface region or area on a substrate by means of a spray head, in which a mask is arranged between the substrate and the spray head, and also to a suitable coating apparatus for performing the method.

2. Description of the Related Art

For many applications only a certain region or area on a component or part is to be coated, which means that a predetermined area is to be coated. In these applications there is a requirement that some regions must be masked or covered during the coating and other regions must be accessible for the coating.

A mask must be used for the above-described area-selective coating of a part or component. The mask protects some regions of the part or component from being coated. For example for this purpose photoresists are employed, which are structured by optical methods. These methods however are time consuming and thus very expensive for large components.

Masks, e.g. made of paper or adhesive strips, are frequently used to cover components in mass production of large numbers of pieces. The masks and the uncovered component areas are coated according to the coating application method by spraying, rolling or other methods. After a certain time interval the mask is removed and in most cases is no longer useable, because the coating has contaminated it. If the contaminated mask were to be used again, the covered regions of the component would be contaminated.

### SUMMARY OF THE INVENTION

The technical problem of the present invention is to provide a coating method and a coating apparatus suitable for performing it, with which an especially rapid location-selective coating of the substrate can be performed.

The features of the independent claims comprise a solution to this technical problem. Advantageous further embodiments are claimed in the appended dependent claims.

The method for coating predetermined areas of a substrate according to the invention, which solves the above-described technical problem regarding the method, comprises the steps of:
a) spraying a coating material with a spray head;
b) arranging a mask between the substrate and the spray head; and
c) during the spraying of step a), keeping the mask at a predetermined distance to the spray head and moving the mask together with the spray head, in order to coat the predetermined areas on the substrate.

The apparatus for coating predetermined areas of a substrate according to the invention, which solves the above-described technical problem regarding the apparatus, comprises a coating head and a mask traveling with it during the coating process, for coating the predetermined areas on the substrate.

By the mask traveling with the spray head at a predetermined position or spacing in relation to the spray head, the application of the mask to the substrate surface to cover respective substrate areas that are not to be coated during the spraying can be dispensed with. The coating process can be performed more rapidly when the application and removal of a mask from the substrate surface are eliminated.

The travel of the mask with the spray head or the motion of the entire unit comprising the mask and spray head occurs with the help of a motion system or manual system, such as linear system, a robot or the like. By selection of this sort of manual system the coating apparatus can be located at various positions in a chamber or room, which permits three-dimensional shapes to be coated. Motion of the mask determines the shape of the coating in this case. Furthermore the flexibility is increased so that the mask can be used for different coating patterns.

In preferred embodiments of the method according to the invention the mask is cleaned at the same time as the coating. Because of that it is guaranteed that the mask opening, which the coating material issues, is not clogged, so that the operation of the coating process is maintained. Furthermore it is guaranteed that these provisions maintain the shape of the opening unchanged, whereby the exact contour or shape of the areas to be coated on the substrate do not decrease. Moreover an undesired application of coating material by uncontrolled dripping or deposition is avoided. Because the mask travels with the spray head direct contact between the mask traveling with the coating head and the substrate is avoided. Thus otherwise inevitable contamination of the substrate by bringing the mask with coating material on it in contact with the substrate surface is no longer possible.

In preferred embodiments of the coating apparatus the mask comprises two elongated elements arranged to form a slot acting as an outlet for the coating material. In order to clean the mask during the coating process, means for cleaning is provided comprising a material strip, which is guided over at least one of the elongated elements. The coating material issues from the slot formed by the at least two elongated elements. The material strip cleans the two elongated elements, when it is guided over or moved around at least one of these elements. In this way the edges of the slot are cleaned so that it cannot be clogged. The material strip can be moved or guided parallel to the slot edges over the elongated elements. The material strip can be guided so that it catches at least part of the spray cone of the spray head. In this way an extensive protection of the apparatus from contamination occurs.

It should be emphasized that at least two elongated elements are required to define the slot so that a coated strip forms on the substrate with a spatially fixed mask. Furthermore it is possible that three or more elongated elements form the slot, so that the shape of the slot can be polygonal, which increases the variability during coating. By added variation of the shape of the coating jet additional arbitrary coating shapes can be obtained. For example, a dotted coating pattern can be obtained.

In order to be able to react flexibly to different sized regions to be coated, the slot width is variable. The slot width is thus adjustable from 0 to 40 mm.

For conveying away the contaminated strip carrying the coating material the material strip is unrolled from a first roll and rolled on a second roll. For this purpose the coating apparatus can be equipped with an electric motor. Because the electric motor is arranged to drive or feed the material strip, the feed speed of the material strip can be easily adjusted according to the amount of coating material that is sprayed in order to use a minimum amount of the material strip or sheet.

In an alternative embodiment that eliminates the material strip for mask cleaning the mask can comprise two parallel disks arrange side-by-side, which rotate during the coating process. In this way centrifugal force is used to remove coating material from the disks when they are rotated with an appropriate rotation speed. The spray produced can be caught in a suitable way with the help of a container.

### BRIEF DESCRIPTION OF THE DRAWING

The objects, features and advantages of the invention will now be illustrated in more detail with the aid of the following description of the preferred embodiments, with reference to the accompanying figures in which:

FIG. 1 is a schematic cross-sectional view through a first embodiment of a coating apparatus according to the invention; and

FIG. 2 is a schematic cross-sectional view through a second embodiment of a coating apparatus according to the invention.

### DETAILED DESCRIPTION OF THE INVENTION

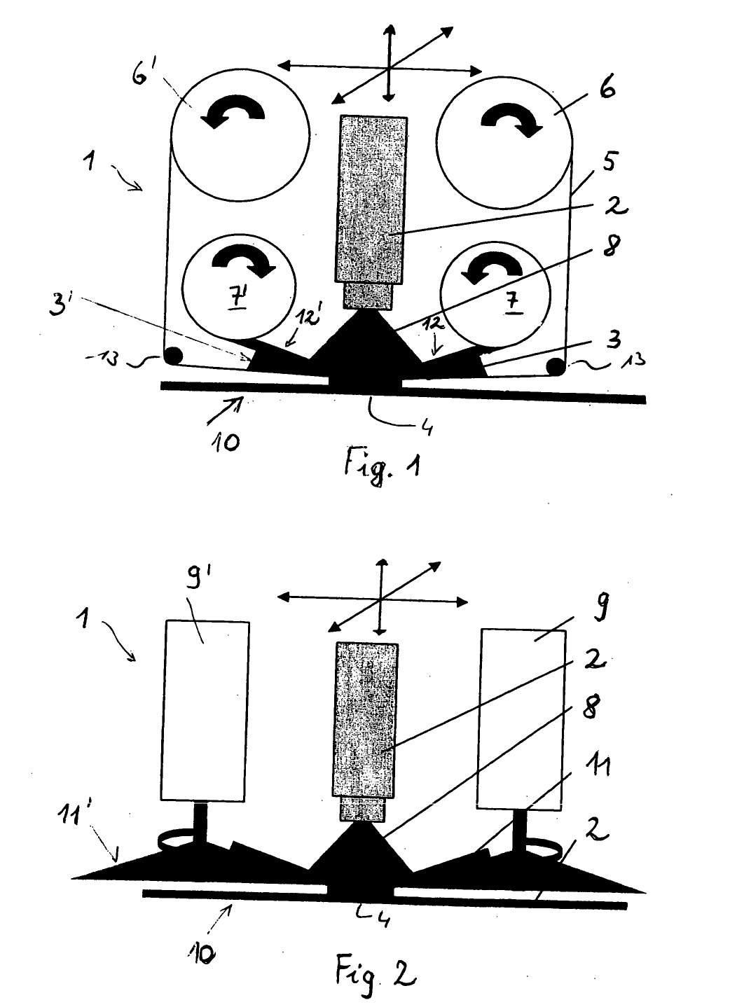

FIG. 1 shows a coating apparatus 1 according to the invention for coating a substrate 10. The coating apparatus 1 comprises a spray head 2, which generates a spray cone 8. It has a mask, which is formed by two elongated elements 3,3′. These elements 3,3′ are elongated in a direction perpendicular to the plane of FIG. 1.

Two pairs of rolls 6,7 and/or 6′, 7′ clean the elongated elements 3, 3′. A respective strip 5 unwinds from rolls 6 and/or 6′, is guided over the elongated elements 3 and/or 3′ and is wound up on roll 7 and/or 7′. In the present embodiment the strip is made of paper. The paper strip is moved with a speed of between 100 and 200 mm/min by an electric motor, which drives the drive spindles of the respective paper rolls 7, 7′ (if necessary also 6, 6′). The coating material from the spray head 2 partially reaches the given area 4 of the substrate 10 to be coated. However it also reaches regions 12 and/or 12′ of the strips 5 as a so-called over-spray. The strips 5 then cover the regions 12, 12′ of the elongated elements 3,3′ and thus the regions of the substrate that are not to be coated.

The coating width is changeable by a transverse adjustment of the rolls 6, 6′; 7,7′ and the guide rods 13,13′. The rolls 7,7′ are provided with a friction brake, which produces a resistance to rotary motion, in order to keep the paper strip 5 under tension. Consumed paper rolls can be replaced by new rolls with the help of a quick-change tool.

The entire spray apparatus 1 according to the invention is moved in a room or chamber with a robot, which is indicated by the crossed arrows above the spray head. The spray apparatus 1 does not bring the mask into contact with the substrate 10 and is moved in relation to the substrate 10 in the embodiment shown in FIG. 1.

In an alternative embodiment according to FIG. 2 a mask comprising two rotating disks 11, 11′ is provided. The disks 11, 11′ are driven by means of electric motors 9, 9′ in opposite rotation directions. The spray head 2 generates a spray cone 8. The coating material reaches the predetermined surface areas of the substrate 10. However it also reaches the rotating disks, which are provided with a TEFLON® coating. This prevents the single component silicon sprayed on the disks 11,11′, which is used in this example as a coating material, from disks to the disks 11,11′. By the peeling or stripping the excess silicon by rotating the disks 11,11′, they are continually cleaned and thus the spray slot is kept clean. Because of that the shape of the coated areas remains sharp, which is very important for well-defined and exact coated area.

The slot defined by the disks 11,11′ is formed in various shapes for coating the surface of the substrate 10 and is adjustable with a slot width between 0 and 40 mm.

The disclosure in German Patent Application 103 59 725.5-45 of Dec. 18, 2003 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in a method of coating and coating apparatus, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

1. A method of coating predetermined areas of a substrate, said method comprising the steps of:
a) spraying a coating material with a spray head;
b) arranging a mask between the substrate and the spray head; and
c) during the spraying of step a), keeping the mask at a predetermined distance to the spray head and moving the mask together with the spray head, in order to coat said predetermined areas of said substrate.

2. The method as defined in claim 1, further comprising cleaning said mask during the spraying.

3. The method as defined in claim 2, wherein said mask comprises two elongated elements, said coating material issues from a slot formed by said two elongated elements during the spraying and said cleaning of said mask comprises guiding a strip of material over at least one of said two elongated elements.

4. The method as defined in claim 3, further comprising unwinding said strip of material from a first roll and winding up said strip of material on a second roll.

5. The method as defined in claim 3 or 4, wherein said strip of material is guided over said at least one elongated element by means of an electric motor.

6. The method as defined in claim 1 or 2, wherein said mask comprises two disks arranged parallel and next to each other and the disks rotate during the coating.

7. The method as defined in claim 1 or 2, wherein said mask is not brought into contact with the substrate during the spraying.

8. A coating apparatus for coating predetermined areas (4) on a substrate (10), said coating apparatus comprising a spray head (2), a mask (3, 3′, 11, 11′) arranged at a predetermined distance from the spray head (2) between the substrate and the spray head and means for traveling or moving the spray head (2) together with the mask (3,3′, 11,11′) in relation to the substrate during the coating.

9. The coating apparatus as defined in claim 8, wherein said means for moving comprises is a robot.

10. The coating apparatus as defined in claim 8, further comprising means for cleaning said mask (3,3′, 11,11′) during said coating and wherein said means for cleaning said mask travels with said mask.

11. The coating apparatus as defined in claim 10, wherein said mask comprises two elongated elements (3,3′) and said two elongated elements are arranged to form a slot.

12. The coating apparatus as defined in claim 11, wherein said means for cleaning said mask comprises a strip (5) of material, which is guided over at least one of the two elongated elements (3, 3′).

13. The coating apparatus as defined in claim 12, wherein said strip (5) of material is associated with an electric motor for moving said strip (5) of material and said strip (5) of material is unwound from a first roll (6,6′) and wound on a second roll (7,7′).

14. The coating apparatus as defined in claim 8, wherein said mask comprises two rotatable parallel disks (11,11′) arranged side-by-side.
